(19) United States
(12) Patent Application Publication
(10) Pub. No.: US 2020/0141778 A1
(43) Pub. Date: May 7, 2020

(54) PULSATION DAMPER FOR A THERMAL FLOW SENSOR

(71) Applicant: Sensirion AG, Stäfa (CH)

(72) Inventor: Jonas Horn, Stäfa (CH)

(73) Assignee: Sensirion AG, Stäfa (CH)

(21) Appl. No.: 16/676,483

(22) Filed: Nov. 7, 2019

(30) Foreign Application Priority Data
Nov. 7, 2018 (DE) 20 2018 106 337.5

(51) Int. Cl. G01F 1/72; G01F 1/684

(52) U.S. Cl. CPC G01F 1/72; F16L 55/04; G01F 1/6842

(57) ABSTRACT

The present invention relate to a pulsation damper for use with a flow sensor adapted to measure a mass flow of a fluid, particularly of a liquid, wherein the pulsation damper is configured to dampen a flow pulsation of the fluid, in case of which the fluid has alternating flow minima and flow maxima, wherein the pulsation damper comprises at least one conduit which extends in an axial direction and comprises a wall which surrounds an interior space of the conduit which is designed for the fluid to pass through, wherein the wall comprises a region extending in the circumferential direction of the wall and configured to be moved by a pressure maximum of the fluid in a direction of the conduit perpendicular to the axial direction from a first position outward to a second position, such that a cross-sectional area of the interior extending perpendicular to the axial direction is enlarged, wherein the cross-sectional area is non-circular when the region of the wall is in the first position.

### CROSS-REFERENCE TO RELATED APPLICATIONS

Benefit is claimed to German utility model application No. 20 2018 106 337.5, filed Nov. 7, 2018; the contents of which are incorporated herein by reference in their entirety.

### FIELD

The invention relates to a pulsation damper for a flow sensor, particularly for a thermal flow sensor (in particular for a microthermal flow sensor).

### BACKGROUND

Such flow sensors can cause problems when measuring pulsating flow rates. Such problems may particularly occur when the peak flow rate exceeds the maximum flow rate range of the flow sensor or when the rate of change of the flow rate exceeds the responsiveness of the flow sensor.

In addition, the pulsating flow causes the flow profile to deviate significantly from the parabolic profile of the stationary flow at higher frequencies and larger channel diameters of the flow sensor. This effect can be characterized by the so-called Womersley number.

FIG. 1 shows said deviation from the parabolic profile.

Since a flow sensor is usually calibrated under stationary flow conditions with a parabolic flow profile and can usually only measure a part of the complete flow profile near the fluid-guiding channel wall (in FIG. 1 area A), the extrapolation results in an error in the measurement of the flow rate, which is exemplarily shown in FIG. 1 by means of the dashed line D. In this example, the error results in an overestimation of the flow rate.

This problem can be counteracted by providing a flexible round tube (as a capacitive element) upstream of the flow sensor, for example. Other solutions add large dead volumes and/or air cushions to the flow path between the flow sensor and a source of the pulsation. Such a source may be, for example, a pulsating pump or a valve that regulates a flow by opening and closing the valve. Furthermore, a pulsation may also occur, for example, in gravity-driven flows, i.e., without pumps or valves (e.g., when handling an infusion bag in infusion therapy).

In addition, pulsation dampers in the form of spring-loaded or gas-damped flexible diaphragms are used on a reservoir.

A particular disadvantage of the existing solutions is the fact that round tubes must either be very flexible, long or have a large inner diameter in order to offer sufficient capacity for damping.

Furthermore, additional vessels used for damping cause a large dead volume and additional parts, fittings and costs that the user typically wants to avoid.

### SUMMARY

Based on the above, the present invention is based on the task of providing an improved pulsation damper.

This problem is solved by a pulsation damper having the features of claim 1, an arrangement having the features of claim 28, and a flow sensor having the features of claim 30.

Advantageous embodiments of these invention aspects are indicated in the corresponding subclaims and are described below.

### BRIEF DESCRIPTION OF THE DRAWINGS

In the following, embodiments as well as further features and advantages of the invention will be explained with reference to the Figures, wherein:

FIG. 1 shows the deviation of the flow profile due to pulsating flow (C), with a Womersley number Wo=6, from the parabolic shape (B), with a Womersley number Wo=0, of the stationary case and a resulting measurement error (in this example an overestimation) in the measurements in the boundary area (A) of the flow channel of the flow sensor;

FIG. 2 shows a schematic cross-sectional view of a thermal flow sensor;

FIG. 3 shows the attenuation behaviour of a first-order low-pass filter as well as the attenuation difference at a 10 times lower cutoff frequency;

FIG. 4 shows arrangements or flow circuits for damping a pulsation of a fluid by means of a pulsation damper according to the invention, which is arranged between a flow sensor and a source (e.g. pump) of the pulsation, wherein furthermore a flow resistance is provided between the pulsation damper and the flow sensor (A), or wherein the flow sensor is arranged between the pulsation damper and the flow resistance (B). FIG. 4(C) schematically shows the damping of the pressure fluctuations by means of the pulsation damper;

FIG. 5 shows a schematic cross-sectional view of a tubular conduit of a pulsation damper according to the invention with a kidney-shaped cross-section;

FIG. 6 shows a deformation of the tube cross-section of the conduit according to FIG. at a pressure peak during a pressure pulsation of the guided fluid;

FIG. 7 shows elastic deformation in a kidney tube (A) compared with the elongation in a round tube (B);

FIG. 8 shows further versions of the tubular conduit of a pulsation damper according to the invention;

FIG. 9 shows a schematic representation of a test setup for measuring the damping of different pulsation dampers;

FIG. 10 shows measurement results obtained with the test setup according to FIG. 9;

FIG. 11 shows a response behaviour of a measured pulsation damper combination with regard to a change in mass flow;

FIG. 12 shows schematic cross-sections of further embodiments of a pulsation damper according to the invention;

FIG. 13 shows a preferred operating range of a pulsation damper according to the invention with a conduit that is kidney-shaped in cross-section; and

FIG. 14 shows sectional views of further embodiments of a pulsation damper according to the invention.

### DETAILED DESCRIPTION

According to claim 1, a pulsation damper for use with a flow sensor is disclosed that is configured to measure a mass flow of a fluid, particularly of a liquid, wherein the pulsation damper is configured to dampen a flow pulsation of a fluid to be supplied to the flow sensor, upon which the fluid comprises alternating flow minima and flow maxima, wherein the pulsation damper comprises at least one conduit extending in an axial direction which comprises an (e.g. circumferential) wall surrounding an interior space of the conduit adapted for passage of the fluid, wherein the wall comprises a region extending in a circumferential direction of the wall, which region is configured to be moved, in particular elastically deformed, from a first position outward to a second position by a pressure maximum of the fluid due to the flow pulsation in a direction of the conduit perpendicular to the axial direction, so that a cross-sectional area of the interior space extending perpendicular to the axial direction is enlarged, wherein the cross-sectional area is non-circular when the region of the wall is in the first position.

The term “elastically deforming” means, in accordance with an embodiment, in particular that the elastic deformation not only changes the cross-sectional area of the interior but also the shape of the cross-sectional area or the contour of the cross-sectional area of the interior perpendicular to the axial direction. In particular, there is not only a mere elongation of the conduit of the pulsation damper. The desired cross-sectional enlargement is thus achieved mainly by a change in shape. This also makes it possible to use less flexible (harder) and therefore more stable hose materials, so that the pulsation damper is more robust against damage or unintentional buckling or denting.

Furthermore, according to an embodiment, it is provided that said cross-sectional area increases in size and that in the operational range the majority (preferably more than 80%) of the increase in size of the cross-sectional area results from the elastic deformation of the wall or circumference of the conduit and only a small proportion (preferably less than 20%) results from the elastic expansion of the wall or circumference of the conduit.

In other words, in case of a circular cross-sectional area, an increase in pressure in the conduit leads to an expansion (change in length) of the circumference without changing the shape of the cross-sectional area. In this case, a change in length of the circumference of 10% causes a change in area of the cross-sectional area of approx. 20%. In case of a non-circular cross-sectional area, the increase in pressure leads both to a change in the shape of the cross-sectional area and to an expansion (change in length) of the circumference or wall of the pipe. If the length of the circumference changes by 10%, the area of the cross-sectional area changes more strongly, i.e. by more than 20%, in particular by more than 80%.

According to an embodiment, the fluid is a liquid.

Preferably, the wall, in particular said area of the wall (or the areas, see below), is elastically deformable.

According to an embodiment of the pulsation damper, it is provided that in the first position said region of the wall forms a concave (i.e. inwardly curved) dent of the wall, wherein the dent extends along the axial direction, preferably over the entire length of the conduit in the axial direction.

According to a further embodiment of the pulsation damper, said cross-sectional area is kidney-shaped when the region of the wall is in the first position and/or that the wall has a kidney-shaped cross-sectional contour when the region of the wall is in the first position.

According to a further embodiment of the pulsation damper, the wall comprises a plurality of regions that are arranged side by side in the circumferential direction, wherein the respective region is configured to be elastically deformed by a pressure maximum of the fluid in a direction of the conduit perpendicular to the axial direction from a first position outward to a second position so as to increase a cross-sectional area of the interior space extending perpendicular to the axial direction, wherein the cross-sectional area is non-circular when the respective region of the wall is in the first position. The respective region particularly extends in the axial direction, preferably over the entire length of the conduit in the axial direction.

According to a further embodiment of the pulsation damper, the wall comprises two opposing regions, wherein the respective region particularly extends along the axial direction (preferably over the entire length of the conduit in the axial direction), wherein the respective region is curved convex in the first position, and wherein the respective region is curved convex more pronounced in the second position, wherein particularly in the first position of the two regions the wall comprises an elliptical or oval cross-sectional contour perpendicular to the axial direction. Furthermore, according to an embodiment, said cross-sectional area of the interior space is elliptical or oval in the first position of each of the two regions.

According to an alternative embodiment of the pulsation damper, the wall comprises three regions arranged side by side in the circumferential direction, which in particular each extend along the axial direction (preferably in each case over the entire length of the conduit in the axial direction), wherein the respective area is flat along the circumferential direction in the first position, so that in the first position of the regions the wall has a triangular cross-sectional contour perpendicular to the axial direction, and wherein the respective area is curved convex in the second position. Furthermore, particularly, said cross-sectional area of the interior space is triangular in the first position of the three regions.

According to a further embodiment of the pulsation damper, the wall comprises four regions arranged side by side in the circumferential direction, wherein particularly each of the four regions extends along the axial direction (in each case preferably over the entire length of the conduit in the axial direction), wherein in the first position the respective region is flat along the circumferential direction, so that in the first position of the regions the wall comprises a rectangular cross-sectional contour perpendicular to the axial direction, and wherein the respective region is curved convex in the second position. Furthermore, in an embodiment, said cross-sectional area of the interior space is rectangular in the first position of the four regions.

According to a further alternative embodiment of the pulsation damper, the wall comprises four regions arranged next to one another in the circumferential direction, wherein particularly each of the four regions extend along the axial direction (in each case preferably over the entire length of the conduit in the axial direction), wherein the respective region is curved concave in the first position, so that in the first position of the regions the wall has a star-shaped cross-sectional contour perpendicular to the axial direction, and wherein the respective region is curved convex in the second position. Furthermore, in an embodiment, said cross-sectional area of the interior space is star-shaped in the first position of the four regions.

According to an embodiment of the pulsation damper, the conduit of the pulsation damper is made out of one of the following materials or comprises one of the following materials: a silicone, polyethylene, a vinyl, a neoprene (e.g. polychloroprene), polyurethane.

Furthermore, according to an embodiment of the pulsation damper, the conduit of the pulsation damper has a Shore A hardness in the range of 30 to 80, particularly in the range of 40 to 70. In particular, the Shore A hardness is 40, 55 or 70.

Furthermore, according to an embodiment of the pulsation damper, the conduit of the pulsation damper has a capacity in the axial direction which lies in the range of 5000 mm³/bar per meter length in the axial direction of the conduit up to 25000 mm³/bar per meter length in the axial direction of the conduit.

Furthermore, according to an embodiment of the pulsation damper, the conduit of the pulsation damper has an inner diameter in the range of 2 mm to 10 mm, particularly in the range of 3 mm to 5 mm, if the region or the respective region of the wall of the conduit is arranged in the first position.

Furthermore, according to an embodiment of the pulsation damper, the conduit of the pulsation damper comprises a length in the axial direction in the range from 5 cm to 100 cm, in particular in the range from 10 cm to 30 cm.

Furthermore, according to an embodiment of the pulsation damper, the conduit is tubular.

Furthermore, according to an embodiment of the pulsation damper, the wall surrounds the interior of the conduit in the circumferential direction, wherein particularly said elastically deformable region of the wall (or the respective elastically deformable region of the wall) forms an integral component of the wall, e.g. is for example integrally formed with the wall.

Furthermore, according to an embodiment of the pulsation damper, the direction perpendicular to the axial direction is a radial direction of the conduit.

According to a further embodiment of the invention, the pulsation damper comprises a further conduit surrounding the conduit of the pulsation damper. This means that the conduit of the pulsation damper, which comprises the region movable from the first position into the second position, is now arranged in an interior space of a further conduit. The further or outer conduit can comprise a circular cross-sectional contour perpendicular to the axial direction. In addition, the further conduit can contact at least a section of an outer side of the (inner) conduit.

Alternatively, according to an embodiment, the wall of the pulsation damper comprises a wall portion, in particular a wall portion integrally formed with the wall, covering said region of the wall. Such a wall portion can be produced, for example, by extruding the entire conduit of the pulsation damper in one piece with the rest of the wall. Here again said wall portion together with an external part of the wall of the conduit can form a circumferential outer side of the pulsation damper which can have a circular cross-sectional contour.

Furthermore, according to an embodiment of the invention, the further or outer conduit comprises a through-opening, or the wall portion covering the movable region of the wall comprises a through-opening. Such through-opening can in particular serve to equalize the pressure when moving or deforming said region of the wall from the first to the second position (or vice versa).

The advantages of such an embodiment comprising an additional outer conduit or additional wall portion are that the outer conduit can be harder and more stable and can thus protect the possibly softer inner conduit from bursting. In addition, the outer conduit can serve as kink protection for the inner conduit. In case of an integrally formed wall portion, said (inner) region of the wall can be thinner and the outer wall portion then has the same function as the separate outer conduit.

Furthermore, according to an embodiment of the pulsation damper, the conduit is formed by a channel formed in a base body, wherein the circumferentially extending region of the wall is a region of an elastically deformable membrane connected to the base body and covering an open side of the channel, so that the base body together with the membrane forms the wall of the conduit, wherein the region of the membrane is curved towards the interior space in the first position.

In the second position, the region of the membrane is raised towards the outside (due to a positive pressure fluctuation in the duct).

Furthermore, according to an embodiment of the pulsation damper, the base body is rigid.

Furthermore, according to an embodiment of the pulsation damper, the base body is monolithic.

Furthermore, according to an embodiment of the pulsation damper, the base body is made of one of the following materials or comprises one of the following materials: a glass, a plastic, a metal.

Furthermore, according to an embodiment of the pulsation damper, the membrane is made out of or comprises one of the following materials: a silicone, polyethylene, a vinyl, a neoprene (e.g. polychloroprene), polyurethane, a metal (e.g. in the form of a metal foil), a liquid crystal polymer.

Furthermore, according to an embodiment of the pulsation damper, in the first position, the region of the membrane is curved V-shaped or U-shaped towards the interior space. In case of a V-shaped curvature, the region of the membrane can form a crease.

Furthermore, according to an embodiment of the pulsation damper, the base body forms two opposing side walls of the conduit (or of the channel), which run towards each other in the direction of a bottom of the channel. In other words, particularly in the case of a V-shaped or

U-shaped membrane inserted into the channel, the channel is adapted to the V-shape (or the U-shape). This minimizes the internal volume of the pulsation damper or the conduit while having the same absolute capacity.

Furthermore, according to an embodiment of the pulsation damper, the membrane is arranged between the base body and a rigid plate of the pulsation damper, which rigid plate forms a stop for the region of the membrane. This plate thus prevents the elastic membrane from bulging beyond the top of the base body upwards/outwards in a case of failure at a too high a pressure.

Furthermore, according to an embodiment of the pulsation damper, the plate comprises a through-opening that faces the region of the membrane.

Such an opening is advantageous for equalizing the pressure in the space between the membrane and the plate. This prevents the intermediate or hollow space between the membrane and the plate from reducing the capacity of the pulsation damper due to back pressure.

A further aspect of the present invention relates to an arrangement comprising a pulsation damper according to the present invention and a flow sensor, wherein the pulsation damper is in flow connection with the flow sensor so that a fluid can be introduced via the pulsation damper into the flow sensor or via the flow sensor into the pulsation damper, wherein particularly the flow sensor is configured to measure a mass flow of the fluid.

According to an embodiment of the arrangement, the arrangement comprises a flow resistance for the fluid, in particular the flow resistance is arranged upstream or downstream of the flow sensor. In particular, the flow resistance is located directly next to the flow sensor and there is no capacitance between them when the flow resistance is on the side facing away from the capacitance.

Furthermore, according to an embodiment of the arrangement, the flow sensor is configured to measure a mass flow of the fluid, wherein the flow sensor comprises a channel for guiding the fluid and at least one temperature sensor which is arranged at the channel and which is configured to generate a temperature signal, and wherein the flow sensor further comprises a heating and/or cooling element, and an analyzing circuit which is configured to measure or determine the mass flow of the fluid from the temperature signal of the at least one temperature sensor. If the flow sensor has two temperature sensors, the heating and/or cooling element can be arranged between the two temperature sensors.

A further aspect of the present invention relates to a use of a pulsation damper according to the invention for damping a flow pulsation of a fluid guided in a conduit.

Finally, a further aspect of the present invention relates to a flow sensor, in particular a microthermal flow sensor, for measuring a mass flow of a fluid (in particular a liquid), wherein a pulsation damper according to the present invention is integrated into the flow sensor, in particular a pulsation damper, in which a channel of a basic body is covered with a membrane (see e.g. above).

Particularly, the channel or the conduit of the pulsation damper can comprise a length in the axial direction which is smaller than 5 cm, preferably smaller than 2 cm.

In particular, the flow sensor can in turn comprise a channel for guiding the fluid which is connected to the channel of the pulsation damper or forms the channel of the pulsation damper, and at least one temperature sensor which is arranged at the channel of the flow sensor (or pulsation damper) and which is configured to generate a temperature signal. Furthermore, the flow sensor may have a heating and/or cooling element and an analyzing circuit configured to measure or determine the mass flow of the fluid from the temperature signal of the at least one temperature sensor. The flow sensor particularly comprises a semiconductor module in which the at least one temperature sensor, the heating and/or cooling element and the analyzing circuit are integrated.

The flow sensor can, for example, be designed in the manner described in EP 3 150 976 A1 or EP 3 187 881 A1, wherein in addition a pulsation damper according to the present invention is integrated into the flow sensor. The channel or the conduit of the pulsation damper is connected to the channel of the flow sensor or is formed by the channel of the flow sensor.

Turning now to the drawings, the present invention relates to a pulsation damper 1 for a (particularly thermal) flow sensor 2. Such a flow sensor 2 is shown in FIG. 2 and is designed to measure a mass flow of a fluid F which is passed through a channel 20 of the flow sensor 2 in a flow direction RS, wherein the sensor 2 has at least one temperature sensor, wherein two temperature sensors T1, T2 are provided as an example, which are arranged one after the other along the channel 20 in the flow direction RS and which are each configured to provide a temperature signal, and wherein the flow sensor 2 further comprises a heating and/or cooling element H arranged between the temperature sensors T1, T2 and configured to heat the fluid F in the channel 20 or to cool the fluid F in the channel. The sensor 1 also comprises an analyzing circuit 21, for example in form of a microchip, which is configured to measure the mass flow of the fluid F from the temperature signals of the two temperature sensors T1, T2.

In the event that the fluid flow F to be measured by sensor 2 exhibits pulsation, i.e. pressure fluctuations with alternating flow minima M and flow maxima M′, measurement inaccuracies with regard to the determination of the mass flow of the fluid F may occur with sensor 2 of the type described above.

Such a pulsation of the fluid F can be generated, for example, by a pump. In principle, such fluid pulsation can also be reduced by introducing damping elements.

Such attenuation is usually a combination of a capacitance and a flow resistance. A cutoff frequency can be defined in analogy to an electrical RC low-pass filter.

As a rule, flow sensors detect only part of the full flow profile near the wall of the sensor channel. The implicit assumption here is that the ratio of flow at the wall to the total flow through the flow channel of the sensor is unambiguous.

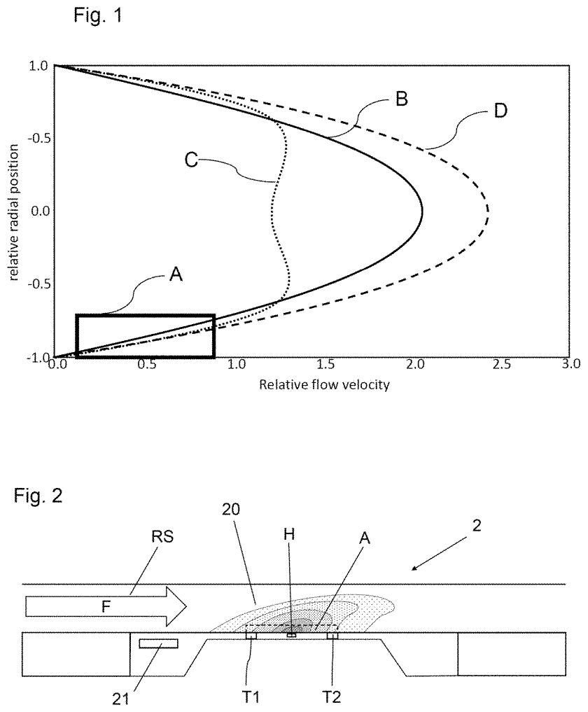

However, an undamped, strong pulsation does not give the flow profile sufficient time to form the characteristic parabola of the constant flow (cf. FIG. 1).

This can cause sensor 2 to overestimate the flow in case of pulsating and rapidly changing flow rates, as shown in FIG. 1. Here, an extrapolation of the flow profile near the wall of channel 20 (area A in FIG. 2) to the center of channel 20 leads to an overestimated flow velocity, as can be seen from the dashed line B.

Two elements are usually of particular interest for damping a flow pulsation. On the one hand, this is a flow resistance, which can be formed, for example, by a thin tube or a small opening. This is comparable to a resistance in an electrical circuit. Furthermore, the fluidic capacitance C is important. This capacitance can, for example, be formed by a flexible hose which changes its internal volume when the applied pressure changes. This is comparable to a capacitor in an electrical circuit.

An optimized combination of these elements results in maximum pulsation damping and optimal measurement performance.

Based on the analogy of the low-pass filter or the RC circuit well understood in electronics, it is possible to define the analogy of the cutoff frequency as a measure of the damping effect of a fluidic low-pass filter:

f_{c}=1/(2πRC)

Experiments show that this analogy works well and allows, for example, a rough estimate of the damping strength of circuits (A) and (B) according to FIG. 4.

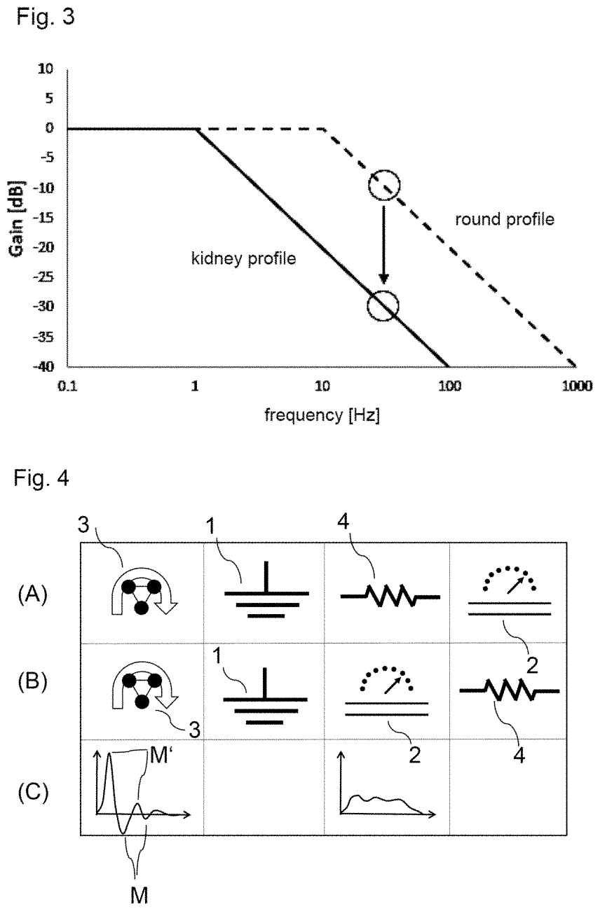

The cutoff frequency f_{c} determines the damping behavior of the filter or pulsation damper 1. From the analogy to a first-order low-pass filter in electronics, a ratio of gain to frequency can be expected, as shown in FIG. 3 for two pulsation dampers having cutoff frequency differing by a factor of 10. The result is that the cutoff frequency f_{c} must be similar to the dominant pulsation of the fluid flow F and ideally smaller.

FIG. 4 schematically shows two possible flow circuits or arrangements (A), (B) comprising a pulsation damper 1 and a flow sensor 2. The circuit according to FIG. 4(A) comprises, for example, a pump 3, as well as a pulsation damper 1 arranged between the pump 3 and a flow sensor 2, wherein furthermore a flow resistance 4 is arranged between the pulsation damper 1 and the flow sensor 2. The arrangement according to FIG. 4(A) provides in most cases the best measurement results of the flow sensor 2. However, the arrangement according to FIG. 4(B) offers design advantages in some applications and should also be considered. In contrast to FIG. 4(A), the flow sensor 2 according to FIG. 4(B) is arranged between the pulsation damper 1 and the flow resistance 4.

FIG. 4(C) schematically shows the damping of the pressure and pulsation fluctuations (alternating flux minima M and flux maxima M′) by means of the pulsation damper 1.

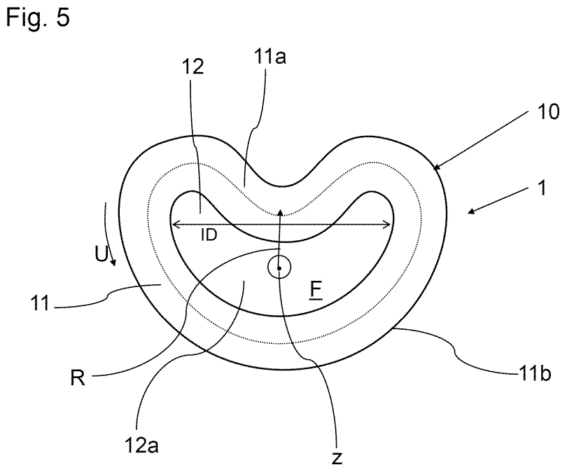

According to the invention, the pulsation damper 1 comprises, according to the embodiment shown in FIG. 5, at least one tubular conduit 10 which extends in an axial direction z and which comprises a circumferential wall 11 which surrounds an interior space 12 of the conduit 10 which is formed for the passage of the fluid F, wherein the circumferential wall 11 comprises a region 11a which extends in the circumferential direction U of the wall 11 and which is configured to be moved or deformed by a pressure or flow maximum fM′ of the fluid F in a radial direction R of the tubular conduit 10 from a first position outward to a second position, so that a cross-sectional area 12a of the interior space 12 extending perpendicular to the axial direction z increases, wherein the cross-sectional area 12a is non-circular when the region 11a of the wall 11 is in the first position.

Particularly, in the first position, the region 11a of wall 11 forms a concave, i.e. inwardly curved, dent in the wall 11 extending along the axial direction z.

Here, it is particularly provided that the cross-sectional area 12a of the interior space 12 is kidney-shaped when the region 11a of the wall 11 is in the first position. Similarly, the wall 11 itself particularly comprises a kidney-shaped cross-sectional contour when region 11a of the wall 11 is in the first position.

In case of the same material or hardness, the same inner diameter ID, and the same length in the axial direction z, the capacitance is approximately 10 times higher compared to a round tube. With reference to FIG. 3, this refers to an amplification of the pulsation power that is −20 dB higher or a pulse amplitude that is 10 times smaller.

The volume of the interior space 12 of the kidney-shaped conduit 10 at a low operating pressure is only a fraction (e.g. ⅕ to ½) of the interior volume of a round pipe with a circular cross-section.

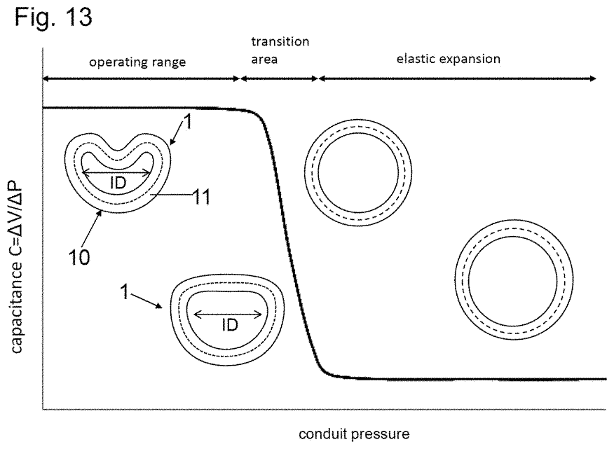

In many applications, a smaller volume in the conduit 10 is desirable. According to FIG. 13, the volume of the interior space 12 of the kidney-shaped conduit 10 is always smaller than the volume of the interior space 12 of a circular pipe with the same inner diameter ID and the same length. At the lower end of the operating range, the volume of the interior space is minimal (less than one third of the volume of a round pipe with a circular cross-section, depending on the design) and, in the transition area, approaches the volume of the conduit with a circular cross-section.

By appropriate selection of the material of the tubular conduit 10 of the pulsation damper 1 (e.g. a silicone, a polyethylene, a vinyl, a neoprene, a polyurethane, a metal, a liquid crystal polymer), the hardness of the material (e.g. silicone with 40, 55, 70 Shore A hardness), the wall thickness t, the inner diameter ID and the length in the axial direction z, the damping effect (together with the selection of the suitable flow resistance) can be adapted to the requirements of the present application.

The specific shape of the wall 11 of the tubular conduit 10 also allows a reliable connection with connectors, as it folds/deforms into a round shape when the connector is inserted into the interior space 12.

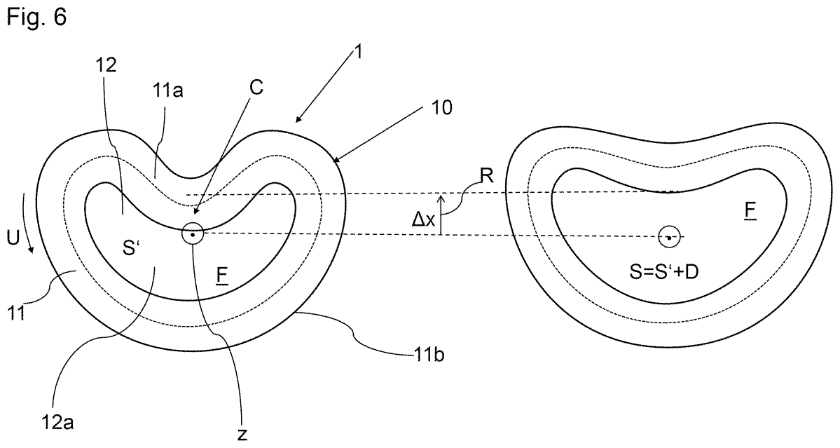

FIG. 6 illustrates how the capacitive effect works with the pulsation damper design according to FIG. 5.

If, during the pressure pulsation of the fluid F, an increased pressure is exerted on the wall 11 of the tubular conductor 10, the point C is displaced in the radial direction R by the amount Δx by a deformation, in particular by folding or bending the wall 11; as a result, the amount S′ of the cross-sectional area 12a of the tubular conductor 10 increases by an area D to S=S′+D. The capacitance of the tubular conduit 10 is C=ΔV/ΔP=(L*D)/ΔP, where ΔP is the pressure difference required for the deformation and L is the length of the tubular conduit 10 in the axial direction z.

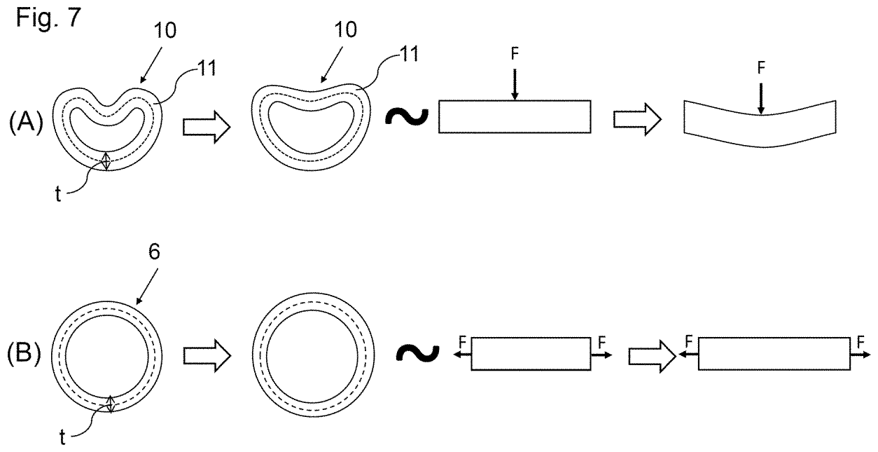

Surprisingly, by means of conduit 10 having a kidney-shaped cross section, a considerably better damping can be achieved compared to a round tube 6. The degree of this advantage can be influenced by the dimensions, in particular the wall thickness t of the wall 11 and the hardness. It should be noted in particular that the folding/bending moment depends more on the wall thickness (˜t³) than the tensile force of the elastic deformation (˜t), cf. FIG. 7.

In the event that the thickness t of the wall of the round tube 6 roughly corresponds to the radius r (t=r) and is comparatively thick, bending the wall gives only a slight advantage over stretching the wall, so that the capacitances C_{kidneyshaped} of the conduit 10 according to the invention and the round tube 6 C_{roundtube} are comparable (C_{kidneyshaped}≥C_{roundtube}).

For the case t<r/2, the wall is thin enough that the bending moment is significantly smaller than the tensile force of the elastic deformation, so that the capacitance of a conduit 10 according to the invention is significantly larger than that of a round pipe 6 (C_{kidneyshaped}˜10*C_{roundtube}).

In the case t<< r, i.e., with very thin-walled conduits 10, the advantage over round tubes 6 is very great, since the wall 11 can be folded very easily (C_{kidneyshaped}>>C_{roundtube}).

In particular in case of a pulsation damper 1 according to the invention with a conduit that is kidney-shaped in cross-section (for example according to the kind of FIG. 5), the present invention has the desirable side effect that the cross-sectional area 12a of the interior space 12 of the tubular conduit 10 is reduced. With a sufficiently long segment, this can act both as flow resistance and as capacitance and thus integrate both functions in one part. This function advantageously reduces the number of additional parts and fluid connections required for the integration. In this respect, regarding FIG. 4 a separate flow resistance 4 can be dispensed with.

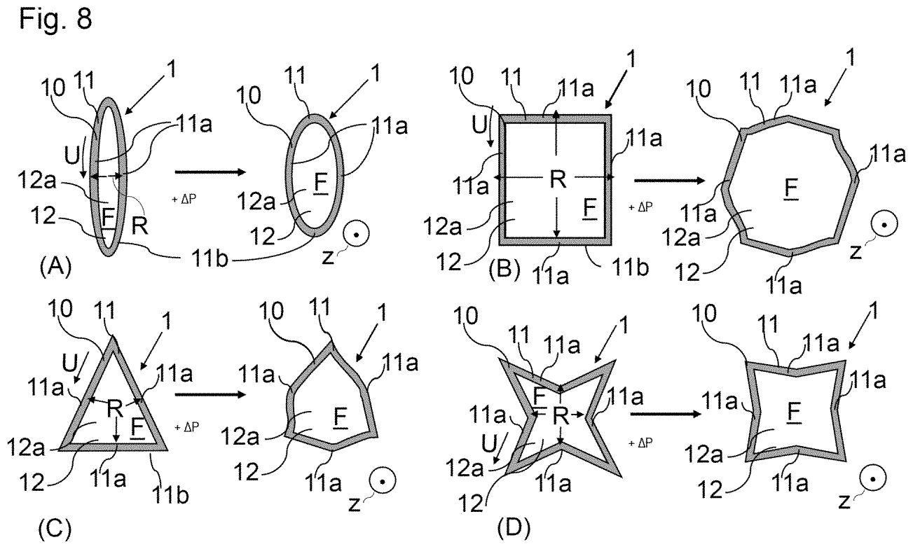

The inventive solution is not limited to kidney-shaped cross sections or cross section contours. Other shapes (e.g. elliptical, oval, rectangular, square, triangular, H-shaped or others) are also possible. FIG. 8 shows in this respect alternative embodiments of the present invention, which also have the advantages over round tubes discussed above.

For example, according to FIG. 8(A), the wall 11 of the tubular conduit 10 can comprise two opposing regions 11a, wherein the respective region 11a is curved convex in the first position, and wherein the respective region 11a is curved convex more pronounced in the second position by pressurization (ΔP) due to the pressure pulsation of the fluid F, wherein particularly the wall 11 comprises an elliptical (or oval) cross-sectional contour perpendicular to the axial direction z in the first position of the two regions 11a and in the second position of the two regions 11a.

Furthermore, for example according to FIG. 8(B), the wall 11 can comprise four regions 11a arranged next to one another in the circumferential direction U, wherein the respective region 11a is flat along the circumferential direction U in the first position, so that the wall 11 has a rectangular cross-sectional contour 11b perpendicular to the axial direction z in the first position of the regions 11a, and wherein the respective region 11a is curved convex (i.e. curved outwards) in the second position.

Furthermore, e.g. according to FIG. 8(C), it may be provided that the wall 11 has only three regions 11a arranged next to one another in the circumferential direction U, wherein the respective region 11a is flat along the circumferential direction U in the first position, so that the wall 11 has a triangular cross-sectional contour 11b perpendicular to the axial direction z in the first position of the regions 11a, and wherein the respective region 11a is curved convex in the second position.

Finally, according to FIG. 8(D), it may also be provided, for example, that the wall 11 comprises four regions 11a arranged next to one another in the circumferential direction U, wherein the respective region 11a is curved concave in the first position so that the wall 11 has a star-shaped cross-sectional contour 11b perpendicular to the axial direction z in the first position of the four regions 11a, and wherein the respective region 11a is curved convex (i.e. curved outwards) in the second position.

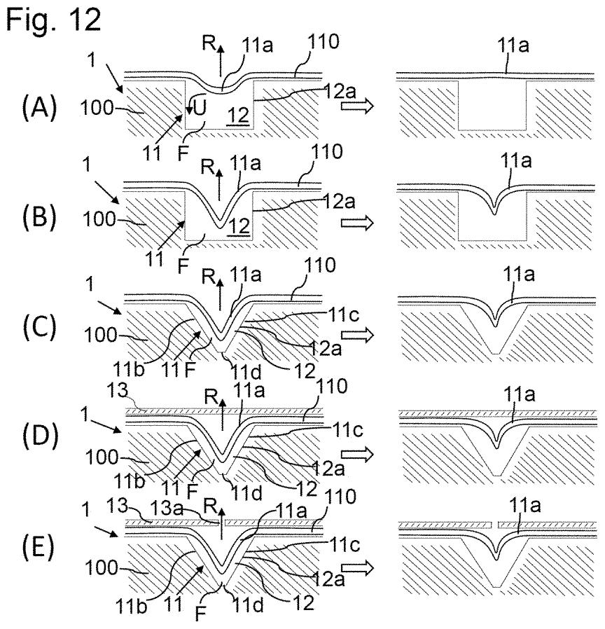

FIG. 12 shows schematic sectional drawings of further embodiments of a pulsation damper 1 according to the invention, where the respective sectional plane is perpendicular to an axial direction z of a conduit 10 of the respective pulsation damper 1.

In the embodiments according to FIG. 12, it is provided in each case that the conduit 10 of the pulsation damper 1 is formed by a channel 10 which is formed in a base body 100 (for example. in the form of a trench), wherein the region 11a of the wall 11 which extends in the circumferential direction U (cf. FIG. 12(A)) is a region 11a of an elastically deformable membrane 110 which is connected to the base body 100 and covers an open side of the channel 10 on a surface of the base body 100, so that the base body 100 together with the membrane 110 forms the wall 11 of the conduit 10 or channel 10. Particularly, the region 11a of the membrane 110 is curved towards the interior space 12 in said first position. The second position of the region 11a is shown on the right-hand side of FIGS. 12(A) to 12(E), wherein the region 11a is raised upwards in the second position (due to a positive pressure fluctuation due to a pulsation of the fluid F guided in the channel 10) or is displaced outwards (away from the interior space 12) in the said direction R perpendicular to the axial direction z.

The base body 100 particularly is a rigid body (in comparison to the membrane 110) made out of, for example, a glass, a plastic material or a metal, wherein the base body 100 can be a monolithic body.

According to the embodiments shown in FIGS. 12(B) to 12(E), said region 11a of the membrane 110 is curved in a V-shaped fashion towards the interior space 12 in the first position (and in particular also in the second position).

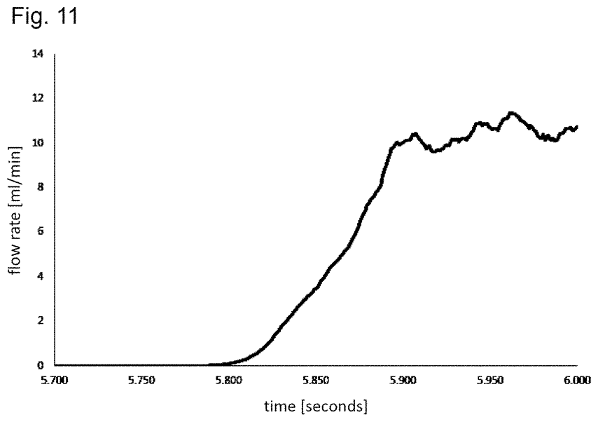

Furthermore, according to the embodiments shown in FIGS. 11(C) to 11(E), the base body 100 can have a tapered cross-section instead of a rectangular cross-section (cf. FIGS. 12(A) and 12(B)). In this respect, the main body 100 may, for example, form two opposing side walls 11b, 11c of the conduit 10 or of the channel 10, which run towards each other in a direction towards a bottom 11d of the channel 10. The interior space 12 of the channel 10 can therefore be tapered in a V-shaped fashion corresponding to the region 11a.

Furthermore, the pulsation damper 1 can comprise a plate 13 according to the embodiment shown in FIG. 12(D), wherein the region 11a of the membrane 110 is arranged between the plate 13 and the base body 100, so that the plate 13 limits a movement of the region 11a outwards.

To allow pressure equalization in the space between plate 13 and region 11a, the plate 13 may have a through-opening 13a according to an embodiment.

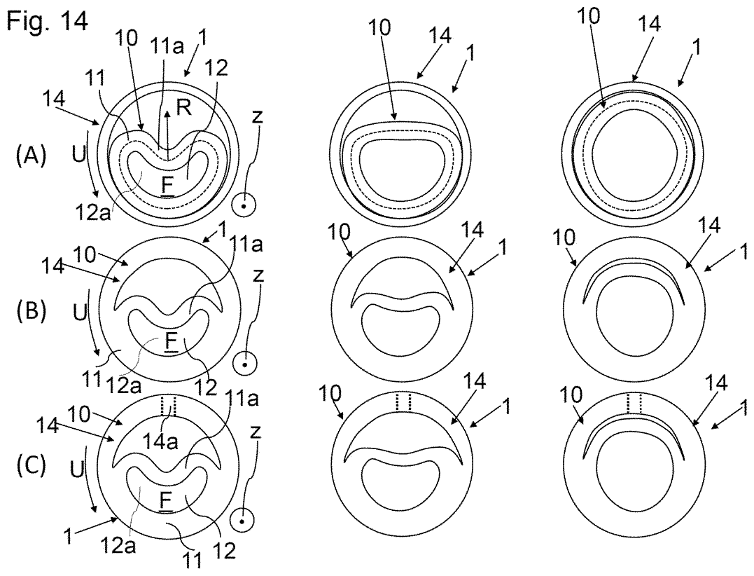

FIG. 14 shows schematic sections of further embodiments of a pulsation damper 1 according to the invention, where the respective section plane runs perpendicular to an axial direction z of a conduit 10 of the respective pulsation damper 1.

In accordance with the embodiment shown in FIG. 14(A), the pulsation damper 1 comprises a further conduit 14 surrounding the conduit 10 of the pulsation damper 1. The inner conduit 10 can, while moving the region 11a of the wall 11 of the inner conduit 10 from the first position to the second position (in the radial direction R), contact the inside of the outer conduit 14 (see right side of FIG. 14(A)).

Alternatively, according to the embodiment shown in FIG. 14(B), the wall 11 of the conduit 10 of the pulsation damper 1 comprises a wall portion 14 that is particularly integrally formed with the wall 11 and covers said movable region 11a of the wall 11. Such a wall portion can be produced, for example, by extruding the entire conduit 10 of the pulsation damper 1 in one piece with the remaining wall.

Furthermore, according to a further embodiment (cf. FIG. 14(C)), the further or outer conduit 14 or the wall portion 14 comprises a through-opening 14a.

The advantages of the embodiments shown in FIGS. 14(A)-(C) with additional outer conduit 14 or additional wall portion 14 are that the outer conduit 14 can be harder and more stable and can thus protect the possibly softer inner conduit 10 or the region 11a of the wall 11 from bursting in the case of failure. In addition, the outer conduit 14 can serve as kink protection for the inner conduit 10. In the case of an integrally formed wall portion 14 (see FIGS. 14(B)-(C)), said (inner) region 11a of the wall 11 can be thinner and the outer wall portion 14 then has the same function as the separate outer conduit 14.

### Examples

The advantages of the present invention can be illustrated by concrete experimental data, which is reproduced below for the combination of four flow resistance and three capacitive tubular conduits, wherein a typical peristaltic pump (approx. 13 ml/min) is used to generate a flow pulsation of approx. 20 Hz of the liquid.

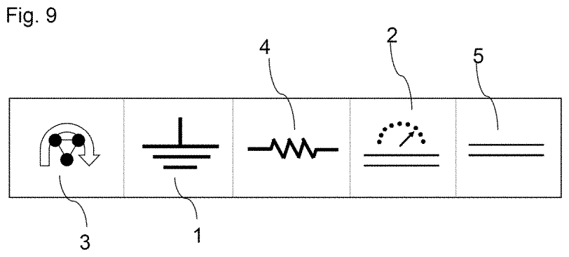

The pump 3, the pulsation damper 1 in the form of the tubular line C0, C1 or C2; the flow resistance in the form of a pipe R0, R1, R2, or R3 made of PEEK; the flow sensor 2 and an outlet pipe 5 are in flow connection to one another according to the sequence schematically shown in FIG. 9.

Specifically, the following elements are used as capacitance or flow resistance for the measurements:

TABLE 1
Capacitive tubular cables or pulsation dampers

| | | inner | | | |
|---|---|---|---|---|---|
| | | diameter | | | |
| | | ID | length | capacitance | capacitance |
| | Description | [mm] | [mm] | [m³*Pa⁻¹] | [mm³*bar⁻¹] |
| C0 | Rigid PFA tube | 3 | 200 | 1.26E−13 | 13 |
| C1 | Circular silicone | 3 | 200 | 1.41E−12 | 141 |
| | tube | | | | |
| C2 | Kidney-shaped | 4 | 200 | 5.04E−11 | 5042 |
| | silicone tube | | | | |

TABLE 2
Flow resistances

| | | inside | | | |
|---|---|---|---|---|---|
| | | diameter | | | Resistance |
| | | ID | length | resistance | [millibar*(ml/ |
| | Description | [mm] | [mm] | [Pa*s*m⁻³] | min)⁻¹] |
| R0 | No additional | n/a | n/a | 7.50E+08 | 0.125 |
| | flow resistance | | | | |
| | (i.e. only | | | | |
| | intrinsic | | | | |
| | resistance of | | | | |
| | the system | | | | |
| | itself) | | | | |
| R1 | PEEK- conduit | 0.75 | 45 | 6.54E+09 | 0.966 |
| R2 | PEEK- conduit | 0.75 | 260 | 3.42E+10 | 5.58 |
| R3 | PEEK- conduit | 0.50 | 260 | 1.70E+11 | 28.2 |

TABLE 3
Combination of the 4 flow resistances and 3 capacitances
or tubular conduits, wherein 12 crossover frequencies
can be calculated for these combinations

| f_{c} [Hz] | C0 | C1 | C2 |
|---|---|---|---|
| R0 | 1679.99 | 150.14 | 4.21 |
| R1 | 192.58 | 17.21 | 0.48 |
| R2 | 36.82 | 3.29 | 0.09 |
| R3 | 7.40 | 0.66 | 0.02 |

Due to the approximate approach, the calculated values are to be understood as rough estimates. However, taking the magnitudes into account, it is possible to conclude the following:

The cutoff frequency f_{c}≈2000 Hz of the combination C0 and R0 (almost without resistance and without capacitance) is two orders of magnitude larger than the pulse frequency of 20 Hz, so that probably no damping effect is visible here.

The cutoff frequencies f_{c}≈200 Hz of the combinations C0-R1 and C1-R0 are still one order of magnitude larger than the pulse frequency. Therefore the damping effect is probably very low.

The cutoff frequencies f_{c}≈5 Hz to 35 Hz of the combinations C0-R2, C0-R3, C1-R1 and C2-R2 are in the order of the pulse frequency. Therefore a certain damping effect is visible.

The cutoff frequencies f_{c}≈<1 Hz of the combinations C1-R3, C2-R1, C2-R2 and C2-R3 are much smaller than the pulse frequency. These combinations have a very strong damping effect on this pulsation.

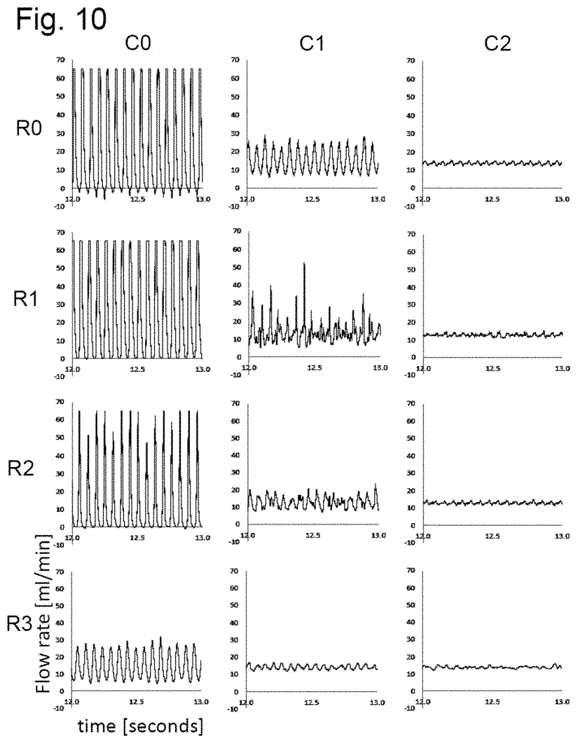

FIG. 10 shows the flow rate data for all measured combinations (1 second each) in ml/min, rounded measured values, measured at a sampling rate of 1000 Hz.

The noise to signal ratio and the measurement errors were calculated from the flow data for each combination of resistance and capacitive tube.

| | C0 | C1 | C2 |
|---|---|---|---|
| Std/Avg (noise to | | | |
| signal ratio) | | | |
| R0 | 2 | 0.5 | 0.05 |
| R1 | 2 | 0.5 | 0.05 |
| R2 | 1.5 | 0.25 | 0.05 |
| R3 | 0.5 | 0.1 | 0.05 |
| Measuring error | | | |
| R0 | >>10% | >5% | <5% |
| R1 | >>10% | >5% | <5% |
| R2 | >10% | ≈5% | <5% |
| R3 | >5% | <5% | <5% |

By comparing the cutoff frequencies with the noise to signal ratio (calculated as the standard deviation of the flow divided by the actual mean flow) and the measurement errors, the following conclusions can be drawn:

The effect of strong attenuation is clearly visible in combinations with very low cutoff frequencies.

The non-circular, kidney-shaped C2 conduits (e.g. in the form of conduit 10 according to FIG. 5) prove to be even more effective than the cutoff frequency would suggest. Even without an additional flow resistance (R1, R2 or R3), only with the intrinsic flow resistance of the sensor and the pipe R0, such a tubular conduit dampens the pulsation almost completely.

Some applications are based on a rapid response of the flow rate to changes in pump performance. Since the capacity has to “charge” for the first time, the response of the flow rate is slightly reduced. Even with the strong damping combination (R2-C2), however, the response time is advantageously only 100 ms, as shown in FIG. 11 using the combination R2-C2.

We claim:

1. A pulsation damper for use with a flow sensor adapted to measure a mass flow of a fluid, particularly of a liquid, wherein the pulsation damper is configured to dampen a flow pulsation of the fluid, in case of which the fluid has alternating flow minima and flow maxima, wherein the pulsation damper comprises at least one conduit which extends in an axial direction and comprises a wall which surrounds an interior space of the conduit which is designed for the fluid to pass through, wherein the wall comprises a region extending in the circumferential direction of the wall and configured to be moved by a pressure maximum of the fluid in a direction of the conduit perpendicular to the axial direction from a first position outward to a second position, such that a cross-sectional area of the interior extending perpendicular to the axial direction is enlarged, wherein the cross-sectional area is non-circular when the region of the wall is in the first position.

2. The pulsation damper according to claim 1, wherein the region of the wall forms an inwardly curved dent of the wall in the first position.

3. The pulsation damper according to claim 1, wherein the cross-sectional area of the interior space is kidney-shaped when the region of the wall is in the first position and/or in that the wall has a kidney-shaped cross-sectional contour when the region of the wall is in the first position.

4. The pulsation damper according to claim 1, wherein the wall comprises a plurality of regions arranged side by side in the circumferential direction, wherein the respective region is configured to be moved by a pressure maximum of the fluid in a direction of the conduit extending perpendicular to the axial direction from a first position outward to a second position, such that a cross-sectional area of the interior which extends perpendicular to the axial direction is enlarged, wherein the cross-sectional area is non-circular when the respective region of the wall is in the first position.

5. The pulsation damper according to claim 4, wherein the wall comprises two opposing regions, wherein the respective region is curved convex in the first position, and wherein the respective region is curved convex more pronounced in the second position, wherein particularly the wall comprises an elliptical or an oval cross-sectional contour perpendicular to the axial direction in the first position of the two regions.

6. The pulsation damper according to claim 4, wherein the wall (11) comprises three regions (11a) arranged next to one another in the circumferential direction (U), wherein the respective region is flat in the first position along the circumferential direction, so that in the first position of the regions the wall comprises a triangular cross-sectional contour perpendicular to the axial direction, and wherein the respective region is curved convex in the second position.

7. The pulsation damper according to claim 4, wherein the wall comprises four regions arranged next to one another in the circumferential direction, wherein the respective region is flat in the first position along the circumferential direction, so that in the first position of the regions the wall comprises a rectangular cross-sectional contour perpendicular to the axial direction, and wherein the respective region is curved convex in the second position.

8. The pulsation damper according to claim 4, wherein the wall comprises four regions arranged next to one another in the circumferential direction, wherein the respective region is curved concave in the first position, so that in the first position of the four regions the wall has a star-shaped cross-sectional contour perpendicular to the axial direction, and wherein the respective region is curved convex in the second position.

9. The pulsation damper according to claim 1, wherein the conduit is tubular.

10. The pulsation damper according to claim 1, wherein the wall surrounds the interior of the conduit in the circumferential direction.

11. The pulsation damper according to claim 1, wherein the direction running perpendicular to the axial direction is a radial direction of the conduit.

12. The pulsation damper according to claim 1, wherein the pulsation damper comprises a further conduit surrounding the conduit, or wherein the wall of the conduit comprises a wall portion covering said region of the wall.

13. The pulsation damper according to claim 12, wherein the further conduit comprises a through-opening, or wherein the wall section comprises a through-opening.

14. The pulsation damper according to claim 1, wherein the conduit is formed by a channel which is formed in a base body, wherein the region of the wall extending in the circumferential direction is a region of an elastically deformable membrane connected to the base body, which membrane covers an open side of the channel, so that the base body together with the membrane forms the wall of the channel, wherein the region of the membrane is curved towards the interior in the first position.

15. The pulsation damper according to claim 14, wherein the base body is rigid.

16. The pulsation damper according to claim 14, wherein the base body is monolithic.

17. The pulsation damper according to claim 14, wherein the base body is formed out of one of the following materials or comprises one of the following materials: a glass, a plastic, a metal.

18. The pulsation damper according to claim 14, wherein the membrane is formed out of or comprises one of the following materials: a silicone, polyethylene, a vinyl, a neoprene, polyurethane, a metal, a liquid crystal polymer.

19. The pulsation damper according to claim 14, wherein in the first position, the region of the membrane is curved V-shaped or U-shaped towards the interior.

20. The pulsation damper according to claim 14, wherein the base body forms two opposing side walls of the conduit which run towards one another in the direction of a bottom of the channel.

21. The pulsation damper according to claim 14, wherein the membrane is arranged between the base body and a rigid plate of the pulsation damper forming a stop for the region of the membrane.

22. The pulsation damper according to claim 21, wherein the plate comprises a through opening which is opposite the region of the membrane.

23. The pulsation damper according to claim 1, wherein the conduit of the pulsation damper consists of one of the following materials or comprises one of the following materials: a silicone, a polyethylene, a vinyl, a neoprene, polyurethane.

24. The pulsation damper according to claim 1, wherein the conduit of the pulsation damper comprises a Shore A hardness which is in the range from 30 to 80, particularly in the range from 40 to 70.

25. The pulsation damper according to claim 1, wherein the conduit of the pulsation damper has a capacitance which lies in the range from 5000 mm³/bar per meter in the axial direction to 25000 mm³/bar per meter in the axial direction.

26. The pulsation damper according to claim 1, wherein the conduit of the pulsation damper has an internal diameter which is in the range from 2 mm to 10 mm, particularly in the range from 3 mm to 5 mm, when the respective region of the wall of the conduit is arranged in the first position.

27. The pulsation damper according to claim 1, wherein the conduit of the pulsation damper comprises a length in the axial direction in the range from 5 cm to 100 cm, in particular in the range from 10 cm to 30 cm.

28. An arrangement, comprising a pulsation damper according to claim 1 and a flow sensor, wherein the pulsation damper is in flow connection with the flow sensor, so that a fluid can be introduced via the pulsation damper into the flow sensor or via the flow sensor into the pulsation damper, wherein particularly the flow sensor is configured to measure a mass flow of the fluid.

29. The arrangement according to claim 28, wherein the flow sensor is configured to measure a mass flow of the fluid, wherein the flow sensor comprises a channel for guiding the fluid and at least one temperature sensor which is arranged at the channel of the flow sensor and which is configured to provide a temperature signal, and wherein the flow sensor further comprises a heating or cooling element, and an analyzing circuit configured to determine the mass flow of the fluid from the temperature signal of the at least one temperature sensor.

30. A flow sensor for measuring a mass flow of a fluid, wherein a pulsation damper according to claim 14 is integrated into the flow sensor.

31. The flow sensor according to claim 30, wherein the channel comprises a length in the axial direction which is smaller than 5 cm, wherein the length is preferably smaller than 2 cm.
